(19) United States
(12) Patent Application Publication
(10) Pub. No.: US 2022/0018353 A1
(43) Pub. Date: Jan. 20, 2022

(54) LIQUID RING PUMP CONTROL

(71) Applicant: EDWARDS TECHNOLOGIES VACUUM ENGINEERING (QINGDAO) CO LTD, Shandong (CN)

(72) Inventors: Andries Daniel Jozef De Bock, Qingdao (CN); Joeri Coeckelbergs, Cologne (DE); Xin Dai, Qingdao (CN)

(21) Appl. No.: 17/309,078

(22) PCT Filed: Oct. 25, 2018
(86) PCT No.: PCT/CN2018/111808

§ 371 Date: Apr. 21, 2021

(51) Int. Cl. F04D 27/00; F04D 17/16

(52) U.S. Cl. CPC F04D 27/004; F04D 17/168

(57) ABSTRACT

A system comprising: a liquid ring pump comprising a chamber and an impeller mounted within the chamber; a driver configured to drive the liquid ring pump so as to cause the impeller to move within the chamber; and a controller configured to, responsive to determining that a speed of the impeller relative to the chamber is below a threshold speed or is zero, control the driver to drive the liquid ring pump so as to cause the impeller to move within the chamber.

This application is a national stage entry under 35 U.S.C. § 371 of International Application No. PCT/CN2018/111808, filed Oct. 25, 2018, the entire contents of which are incorporated herein by reference.

### TECHNICAL FIELD

The present disclosure relates to the control of liquid ring pumps.

### BACKGROUND

Liquid ring pumps are a known type of pump which are typically commercially used as vacuum pumps and as gas compressors. Liquid ring pumps typically include a housing with a chamber therein, a shaft extending into the chamber, an impeller mounted to the shaft, and a drive system such as a motor operably connected to the shaft to drive the shaft. The impeller and shaft are positioned eccentrically within the chamber of the liquid ring pump.

In operation, the chamber is partially filled with an operating liquid (also known as a service liquid). When the drive system drives the shaft and the impeller, a liquid ring is formed on the inner wall of the chamber, thereby providing a seal that isolates individual volumes between adjacent impeller vanes. The impeller and shaft are positioned eccentrically to the liquid ring, which results in a cyclic variation of the volumes enclosed between adjacent vanes of the impeller and the liquid ring.

In a portion of the chamber where the liquid ring is further away from the shaft, there is a larger volume between adjacent impeller vanes which results in a smaller pressure therein. This allows the portion where the liquid ring is further away from the shaft to act as a gas intake zone. In a portion of the chamber where the liquid ring is closer to the shaft, there is a smaller volume between adjacent impeller vanes which results in a larger pressure therein. This allows the portion where the liquid ring is closer to the shaft to act as a gas discharge zone.

Examples of liquid ring pumps include single-stage liquid ring pumps and multi-stage liquid ring pumps. Single-stage liquid ring pumps involve the use of only a single chamber and impeller. Multi-stage liquid ring pumps (e.g. two-stage) involve the use of multiple chambers and impellers connected in series.

### SUMMARY

The present inventors have realised that seizure of liquid ring pumps may occur during long shutdown periods, i.e. periods during which the liquid ring pump is not functioning. In particular, the present inventors have realised that corrosion of the impeller vanes and/or the chamber, and/or small particles or sediment within the chamber may result in seizure between the impeller vane end surfaces and the internal surface of the chamber. The present inventors have realised that it would be beneficial to prevent or reduce the likelihood of liquid ring pump seizure, for example during shutdown periods.

The present inventors have further realised that liquid ring pump seizure can be prevented, or its likelihood, reduced by causing (e.g. automatically) the impeller to be rotated periodically within the chamber, for example by rotating the shaft upon which the impeller is mounted.

In a first aspect, the present disclosure provides a system comprising a liquid ring pump comprising a chamber and an impeller mounted within the chamber, a driver configured to drive the liquid ring pump so as to cause the impeller to move within the chamber, and a controller configured to, responsive to determining that a speed of the impeller relative to the chamber is below a threshold speed or is zero, control the driver to drive the liquid ring pump so as to cause the impeller to move within the chamber.

The controller may be configured to determine that the speed of the impeller relative to the chamber has been below a threshold speed or has been zero at least for a first predetermined time period. The controlling of the driver to drive the liquid ring pump may be performed responsive to the controller determining that the speed of the impeller relative to the chamber has been below a threshold speed or has been zero at least for the first predetermined time period. The system may further comprise a timer configured to time the first predetermined time period. The controller may be configured to, responsive to determining that a speed of the impeller relative to the chamber is below a threshold speed or is zero, start the timer. The controller may be configured to, after controlling the driver to drive the liquid ring pump, reset the timer.

The system may further comprise one or more sensors configured to detect movement of the impeller relative to the chamber, wherein the controller is configured to determine that a speed of the impeller relative to the chamber is below a threshold speed or is zero using measurements taken by the one or more sensors.

The controller may be configured to determine that a speed of the impeller relative to the chamber is below a threshold speed or is zero using one or more of: a measurement of a speed of a motor arranged to drive the liquid ring pump; a measurement of a power consumption of a motor arranged to drive the liquid ring pump; a finite state machine of control software for controlling the liquid ring pump; and a measurement of vibration of the liquid ring pump.

The driver may comprise a motor configured to rotate a shaft upon which the impeller is mounted. The driver may comprise a pump configured to inject an operating liquid into the chamber.

The controller may be configured to, responsive to determining that a speed of the impeller relative to the chamber is below a threshold speed or is zero, control the driver to cause the impeller to be moved periodically within the chamber.

The controller may be configured to, responsive to determining that a speed of the impeller relative to the chamber is below a threshold speed or is zero, control the driver to cause the impeller to be rotated within the chamber.

In a further aspect, the present disclosure provides a method for controlling operation of a liquid ring pump. The liquid ring pump comprises a chamber and an impeller mounted within the chamber. The method comprises: determining that a speed of the impeller relative to the chamber is below a threshold speed or is zero; and, responsive to determining that the speed of the impeller relative to the chamber is below a threshold speed or is zero, controlling a driver to drive the liquid ring pump so as to cause the impeller to move within the chamber.

Determining that the speed of the impeller relative to the chamber is below a threshold speed or is zero may comprise determining that the impeller is stationary relative to the chamber.

The method may further comprise, repeatedly: responsive to determining that the speed of the impeller relative to the chamber is below a threshold speed or is zero, starting a timer; responsive to the timer timing a first predetermined time period for which the speed of the impeller relative to the chamber remains below a threshold speed or zero, controlling a driver to drive the liquid ring pump so as to cause the impeller to move within the chamber for a second predetermined time period; and resetting the timer.

In a further aspect, the present disclosure provides an anti-seizure apparatus for use with a liquid ring pump. The anti-seizure apparatus is configured to, during a period of inactivity of the liquid ring pump, periodically drive the liquid ring pump.

In a further aspect, the present disclosure provides a system comprising a liquid ring pump, and a controller configured to activate the liquid ring pump responsive to determining that the liquid ring pump has been inactive for a predetermined time period.

In any of the above aspects, the system may further comprise a pump configured to pump an operating liquid to the liquid ring pump via an operating liquid line. The controller may be a controller selected from the group of controllers consisting of a proportional controller, an integral controller, a derivative controller, a proportional-integral controller, a proportional-integral-derivative controller, a proportional-derivative controller, and a fuzzy logic controller. The system may further comprise an operating liquid recycling system configured to recycle operating liquid in the exhaust fluid of the liquid ring pump back into the liquid ring pump. The operating liquid recycling system may comprise a separator configured to separate operating liquid from the exhaust fluid of the liquid ring pump. The operating liquid recycling system may comprise a cooling means configured to cool the recycled operating liquid prior to the recycled operating liquid being received by the liquid ring pump. The system may further comprise a non-return valve disposed on a suction line of the liquid ring pump. The non-return valve may be configured to permit fluid flow into the liquid ring pump and to oppose fluid flow out of the liquid ring pump.

### BRIEF DESCRIPTION OF THE DRAWINGS

FIG. 1 is a schematic illustration (not to scale) showing a vacuum system.

FIG. 2 is a schematic illustration (not to scale) of a liquid ring pump.

FIG. 3 is a process flow chart showing certain steps of an anti-seizure method.

### DETAILED DESCRIPTION

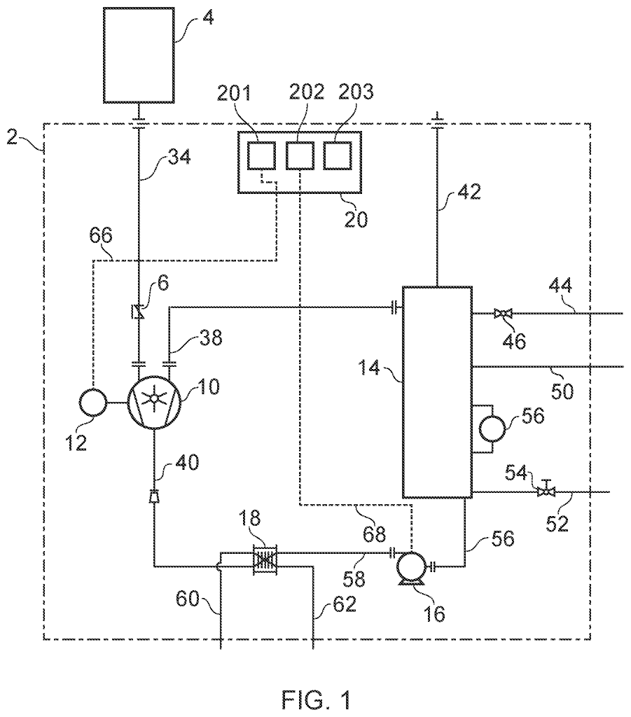

FIG. 1 is a schematic illustration (not to scale) showing a vacuum system 2. The vacuum system 2 is coupled to a facility 4 such that, in operation, the vacuum system 2 establishes a vacuum or low-pressure environment at the facility 4 by drawing gas (for example, air) from the facility 4.

In this embodiment, the vacuum system 2 comprises a non-return valve 6, a liquid ring pump 10, a motor 12, a separator 14, a pump system 16, a heat exchanger 18, and a controller 20.

The facility 4 is connected to an inlet of the liquid ring pump 10 via a suction or vacuum line or pipe 34.

The non-return valve 6 is disposed on the suction line 34. The non-return valve 6 is disposed between the facility 4 and the liquid ring pump 10.

The non-return valve 6 is configured to permit the flow of fluid (e.g. a gas such as air) from the facility 4 to the liquid ring pump 10, and to prevent or oppose the flow of fluid in the reverse direction, i.e. from the liquid ring pump 10 to the facility 4.

In this embodiment, the liquid ring pump 10 is a single-stage liquid ring pump.

A gas inlet of the liquid ring pump 10 is connected to the suction line 34. A gas outlet of the liquid ring pump 10 is connected to an exhaust line or pipe 38. The liquid ring pump 10 is coupled to the heat exchanger 18 via a first operating liquid pipe 40. The liquid ring pump 10 is configured to receive the operating liquid from the heat exchanger 18 via the first operating liquid pipe 40. The liquid ring pump 10 is driven by the motor 12. Thus, the motor 12 is a driver of the liquid ring pump 10.

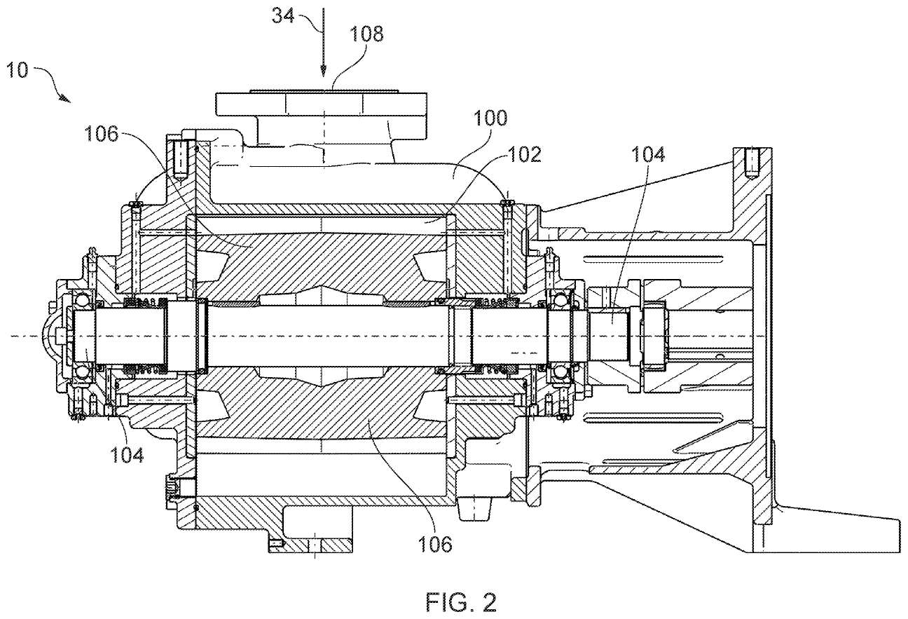

FIG. 2 is a schematic illustration (not to scale) of a cross section of an example liquid ring pump 10. The remainder of the vacuum system 2 will be described in more detail later below after a description of the liquid ring pump 10 shown in FIG. 2.

In this embodiment, the liquid ring pump 10 comprises a housing 100 that defines a substantially cylindrical chamber 102, a shaft 104 extending into the chamber 102, and an impeller 106 fixedly mounted to the shaft 104. The gas inlet 108 of the liquid ring pump 10 (which is coupled to the suction line 34) is fluidly connected to a gas intake of the chamber 102. The gas outlet (not shown in FIG. 2) of the liquid ring pump 10 is fluidly connected to a gas output of the chamber 102.

During operation of the liquid ring pump 10, the operating liquid is received in the chamber 102 via the first operating liquid pipe 40. In some embodiments, operating liquid may additionally be received via the suction line 34 via a spray nozzle. Also, the shaft 104 is rotated by the motor 12, thereby rotating the impeller 106 within the chamber 102. As the impeller 106 rotates, the operating liquid in the chamber 102 (not shown in the Figures) is forced against the walls of the chamber 102 thereby to form a liquid ring that seals and isolates individual volumes between adjacent impeller vanes. Also, gas (such as air) is drawn into the chamber 102 from the suction line 34 via the gas inlet 108 and the gas intake of the chamber 102. This gas flows into the volumes formed between adjacent vanes of the impeller 106. The rotation of the impeller 106 compresses the gas contained within the volume as it is moved from the gas intake of the chamber 102 to the gas output of the chamber 102, where the compressed gas exits the chamber 102. Compressed gas exiting the chamber 102 then exits the liquid ring pump via the gas outlet and the exhaust line 38.

Returning now to the description of FIG. 1, the exhaust line 38 is coupled between the gas outlet of the liquid ring pump 10 and an inlet of the separator 14. The separator 14 is connected to the liquid ring pump 10 via the exhaust line 38 such that exhaust fluid (i.e. compressed gas, which may include water droplets and/or vapour) is received by the separator 14.

The separator 14 is configured to separate the exhaust fluid received from the liquid ring pump 10 into gas (e.g. air) and the operating liquid. Thus, the separator 14 provides for recycling of the operating liquid.

The gas separated from the received exhaust fluid is expelled from the separator 14, and the vacuum system 2, via a system outlet pipe 42.

In this embodiment, the separator 14 comprises a further inlet 44 via which the separator 14 may receive a supply of additional, or “top-up”, operating liquid from an operating liquid source (not shown in the Figures). A first valve 46 is disposed along the further inlet 44. The first valve 46 is configured to control the flow of the additional operating liquid into the separator 14 via the further inlet 44. The first valve 46 may be a solenoid valve.

The separator 14 comprises three operating liquid outlets. A first operating liquid outlet of the separator 14 is coupled to the pump system 16 via a second operating liquid pipe 48 such that operating liquid may flow from the separator 14 to the pump system 16. A second operating liquid outlet of the separator 14 is coupled to an overflow pipe 50, which provides an outlet for excess operating liquid. A third operating liquid outlet of the separator 14 is coupled to a drain or evacuation pipe 52, which provides a line via which the separator can be drained of operating liquid. A second valve 54 is disposed along the evacuation pipe 52. The second valve 54 is configured to be in either an open or closed state thereby to allow or prevent the flow of the operating liquid out of the separator 14 via the evacuation pipe 52, respectively. The second valve 54 may be a solenoid valve.

The separator 14 further comprises a level indicator 56 which is configured to provide an indication of the amount of operating liquid in the separator 14, e.g. to a human user of the vacuum system 2. The level indicator 56 may include, for example, a transparent window through which a user may view a liquid level within a liquid storage tank of the separator 14.

In this embodiment, in addition to being coupled to the separator 14 via the second operating liquid pipe 48, the pump system 16 is coupled to the heat exchanger 18 via a third operating liquid pipe 58. The pump system 16 comprises a pump (e.g. a centrifugal pump) and a motor configured to drive that pump. The pump system 16 is configured to pump operating liquid out of the separator 14 via the second operating liquid pipe 48, and to pump that operating liquid to the heat exchanger 18 via the third operating liquid pipe 58.

The heat exchanger 18 is configured to receive relatively hot operating liquid from the pump system 16, to cool that relatively hot operating liquid to provide relatively cool operating liquid, and to output that relatively cool operating liquid.

In this embodiment, the heat exchanger 18 is configured to cool the relatively hot operating liquid flowing through the heat exchanger 18 by transferring heat from that relatively hot operating liquid to a fluid coolant also flowing through the heat exchanger 18. The operating liquid and the coolant are separated in the heat exchanger 18 by a solid wall via which heat is transferred, thereby to prevent mixing of the operating liquid with the coolant. The heat exchanger 18 receives the coolant from a coolant source (not shown in the Figures) via a coolant inlet 60. The heat exchanger 18 expels coolant (to which heat has been transferred) via a coolant outlet 62.

The heat exchanger 18 comprises an operating liquid outlet from which the cooled operating liquid flows (i.e. is pumped by the pump system 16). The operating liquid outlet is coupled to the first operating liquid pipe 40. Thus, the heat exchanger 18 is connected to the liquid ring pump 10 via the first operating liquid pipe 40 such that, in operation, the cooled operating liquid is pumped by the pump system 16 from the heat exchanger 18 to the liquid ring pump 10.

The controller 20 may comprise one or more processors. In this embodiment, the controller 20 comprises two variable frequency drives (VFD), namely a first VFD 201 and a second VFD 202. The first VFD 201 is configured to control the speed of the motor 12. The first VFD 201 may comprise an inverter for controlling the motor 12. The second VFD 202 is configured to control the speed of the motor of the pump system 16. The second VFD 202 may comprise an inverter for controlling the motor of the pump system 16.

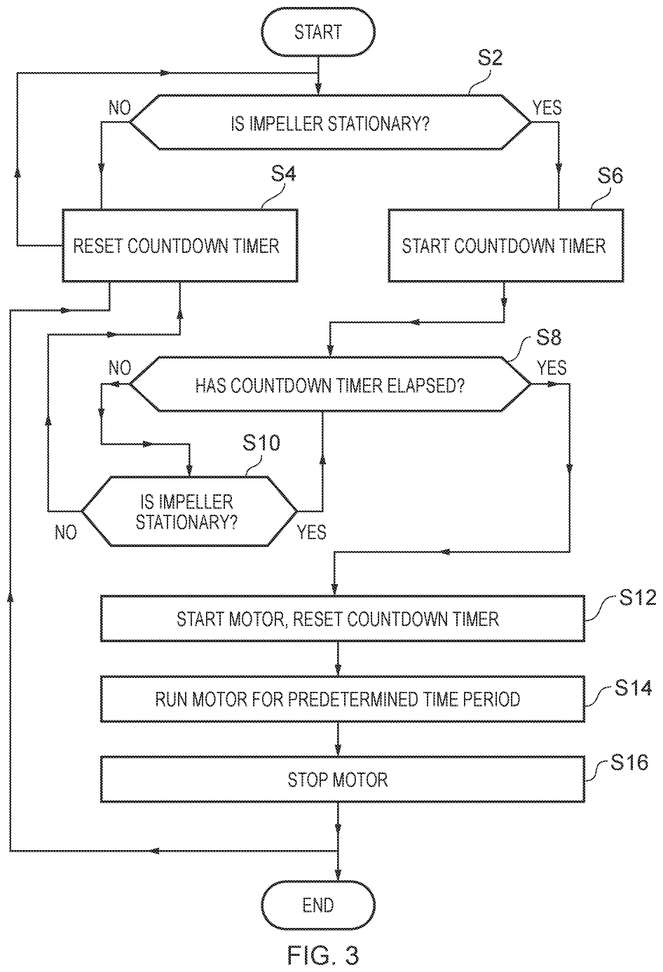

The controller further comprises a countdown timer 203. In this embodiment, the countdown timer 203 is configured to count down from a first predetermined time to zero. In this embodiment, the countdown timer 203 is used to control operation of the motor 12, as described in more detail later below with reference to FIG. 3.

The controller 20 is connected to the motor 12 via a first of its VFDs and via a first connection 66 such that a control signal for controlling the motor 12 may be sent from the controller 20 to the motor 12. The first connection 66 may be any appropriate type of connection including, but not limited to, an electrical wire or an optical fibre, or a wireless connection. The motor 12 is configured to operate in accordance with the control signal received by it from the controller 20. Control of the motor 12 by the controller 20 is described in more detail later below with reference to FIG. 3.

The controller 20 is connected to the pump system 16 via a second of its VFDs and via a second connection 68 such that a control signal for controlling the pump system 16 may be sent from the controller 20 to the motor of the pump system 16. The second connection 68 may be any appropriate type of connection including, but not limited to, an electrical wire or an optical fibre, or a wireless connection. The pump system 16 is configured to operate in accordance with the control signal received by it from the controller 20.

The controller 20 may also be connected to the first valve 46 and the second valve 54 via respective connections (not shown in the Figures) such that a control signals for controlling the valves 46, 54 may be sent from the controller 20 to the valves 46, 54.

Thus, an embodiment of the vacuum system 2 is provided.

Apparatus, including the controller 20, for implementing the above arrangement, and performing the method steps to be described later below, may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine-readable storage medium such as computer memory, a computer disk, ROM, PROM etc., or any combination of these or other storage media.

An embodiment of a control processes performable by the vacuum system 2 will now be described with reference to FIG. 3. It should be noted that certain of the process steps depicted in the flowchart of FIG. 3 and described below may be omitted or such process steps may be performed in differing order to that presented below and shown in FIG. 3. Furthermore, although all the process steps have, for convenience and ease of understanding, been depicted as discrete temporally-sequential steps, nevertheless some of the process steps may in fact be performed simultaneously or at least overlapping to some extent temporally.

FIG. 3 is a process flow chart showing certain steps of an embodiment of a control process implemented by the vacuum system 2.

At step s2, the controller 20 determines whether the impeller 106 is stationary within the chamber 102 of the liquid ring pump 10. The impeller 106 being stationary may correspond to the liquid ring pump 10 having been shutdown or turned off, or the liquid ring pump 10 not functioning.

The controller 20 may determine whether the impeller 106 is stationary in any appropriate way. For example, the controller 20 may measure or monitor the speed of the motor 12, e.g. using an appropriate sensor which may be mounted to the motor 12. If the speed of the motor 12 is zero, or below some predetermined threshold value (for example, less than or equal to 0.1 rpm), the controller 20 may determine that the impeller 106 is substantially stationary. As another example, the controller 20 may determine whether the impeller 106 is stationary using the software finite state (e.g. using state “off” and “stand by”). The software finite state may be stored by or be accessible by the controller 20. The software finite state may specify that the liquid ring pump 10 is in an “off” state, corresponding to the impeller 106 being stationary. As another example, the controller 20 may determine whether the impeller 106 is stationary based on a measurement of power consumption or use by the motor 12. If the power consumption/use of the motor 12 is below a predetermined threshold amount, the controller 20 may determine that the impeller 106 is substantially stationary. Power consumption or use by the motor 12 may be measured or monitored by the controller using any appropriate sensor measurements. As another example, the controller 20 may determine whether the impeller 106 is stationary based on vibration data associated with the liquid ring pump 10. For example, a vibration sensor, which may be mounted to the liquid ring pump 10, may measure vibration of the liquid ring pump 10 and send the vibration measurements to the controller 12. Vibration of the liquid ring pump 10 may be caused by rotation of the impeller 106 within the chamber 102. If the measured vibration of the liquid ring pump 10 is below a predetermined threshold, the controller 20 may determine that the impeller 106 is substantially stationary.

If, at step s2, the controller 12 determines that the impeller 106 is not stationary within the chamber 102 of the liquid ring pump 10, i.e. that the impeller 106 is being rotated, the method of FIG. 3 proceeds to step s4. The impeller 106 moving may be due to the controller activating the motor 12 (via an inverter) to meet process demand.

However, if, at step s2, the controller 12 determines that the impeller 106 is stationary within the chamber 102 of the liquid ring pump 10, the method of FIG. 3 proceeds to step s6. Step s6 will be described in more detail later below after the description of step s4.

At step s4, in this embodiment, responsive to determining that the impeller 106 is not stationary within the chamber 102 of the liquid ring pump 10, the controller 20 resets the countdown timer 203. In some embodiments, if the countdown timer 203 has not been started (i.e. it has not begun to count down), resetting of the countdown timer 203 may be omitted. In this embodiment, resetting of the countdown timer 203 does not start the countdown timer 203.

After step s4, the process of FIG. 3 restarts, i.e. the method proceeds back to step s2 at which stage the controller 20 determines whether the impeller 106 is stationary within the chamber 102 of the liquid ring pump 10.

Returning now to the case where, at step s2, the controller 12 determines that the impeller 106 is stationary within the chamber 102 of the liquid ring pump 10, at step s6 the controller 20 activates or starts the countdown timer 203. Thus, the countdown timer 203 begins counting down from the first predetermined time to zero. The first predetermined time may be any appropriate time, for example a time less than or equal to 24 hours, or less than or equal to 18 hours, or less than or equal to 12 hours, or less than or equal to 6 hours, or less than or equal to 3 hours, or less than or equal to 1 hour. For example, the first predetermined time may be 24 hours, 18 hours, 12 hours, 6 hours, 5 hours, 4 hours, 3 hours, 2 hours, or 1 hour.

At step s8, the controller 20 determines whether the countdown timer 203 has elapsed, i.e. whether the countdown timer 203 has finished counting down from the first predetermined time to zero.

If, at step s8, the controller 12 determines that the countdown timer 203 has not elapsed, i.e. that the countdown timer 203 is still in the process of counting down from the first predetermined time to zero, the method of FIG. 3 proceeds to step s10.

However, if, at step s8, the controller 12 determines that the countdown timer 203 has elapsed, i.e. that the countdown timer 203 has finished counting down from the first predetermined time to zero, the method of FIG. 3 proceeds to step s12. Step s12 will be described in more detail later below after the description of step s10.

At step s10, in this embodiment, responsive to determining that the countdown timer 203 has not elapsed, the controller 20 determines whether the impeller 106 is still stationary within the chamber 102 of the liquid ring pump 10. The controller 20 may determine whether the impeller 106 is stationary in the same way as performed at step s2, described in more detail above.

If, at step s10, the controller 12 determines that the impeller 106 is not stationary within the chamber 102 of the liquid ring pump 10, i.e. that the impeller 106 is being rotated, the method of FIG. 3 proceeds to back to step s4 at which stage the controller 20 stops and resets the countdown timer 203.

However, if, at step s10, the controller 12 determines that the impeller 106 is stationary within the chamber 102 of the liquid ring pump 10, the method of FIG. 3 proceeds back to step s8, at which stage the controller 20 determines whether the countdown timer 203 has elapsed.

Steps s8 and s10 may be performed such that, while the countdown timer 203 is counting down, the controller 12 continually or continuously monitors the impeller 106 to determine whether the impeller 106 is stationary until either the impeller 106 is no longer stationary (i.e. the impeller 106 is rotated) or the countdown timer 203 has elapsed.

Returning now to the case where, at step s8, the controller 20 determines that the countdown timer 203 has elapsed, at step s12 the controller 20 controls the motor 12 to drive the liquid ring pump 10. In other words, the controller 20 controls the motor 12 to move or rotate the shaft 104, thereby moving or rotating the impeller 106 within the chamber 102.

In some embodiments, at step s12, responsive to determining that the countdown timer 203 has elapsed, the controller 20 stops and resets the countdown timer 203.

At step s14, the controller 20 controls the motor 12 such that the impeller 106 is moved or rotated within the chamber 102 for a predetermined drive duration. The predetermined drive duration may be a second predetermined time period. The predetermined drive duration may be any appropriate time period or duration, for example a time period less than or equal to 5 seconds, e.g. a time period between 1 second and 5 seconds. For example, the predetermined drive duration may be 1 s, 2 s, 3 s, 4 s, or 5 s. In controlling the motor 12 at step s14, the controller 20 may implement a further countdown timer that is configured to count down from the predetermined drive time to zero.

The controller 20 may control the motor 12 to move or rotate the impeller 106 within the chamber 102 at a predetermined drive speed. In some embodiments, this drive speed is the lowest possible drive speed. Preferably, the predetermined drive speed is a speed that avoids significant process vacuum disturbance, i.e. such that additional process gas is not drawn from the facility 4. In some embodiments, the predetermined drive speed is less than or equal to 10 Hz, or more preferably, less than or equal to 5 Hz. For example, the predetermined drive speed may be 1 Hz, 2 Hz, 3 Hz, 4 Hz, 5 Hz, 6 Hz, 7 Hz, 8 Hz, 9 Hz, or 10 Hz.

At step s16, after the liquid ring pump 10 has been driven by the motor for the predetermined drive duration, the controller 20 controls the motor 12 to stop driving the liquid ring pump 10. In other words, in this embodiment, the motor 12 is deactivated and the impeller 106 stops moving within the chamber 102.

After step s16, the method of FIG. 3 proceeds to back to step s4 at which stage the controller 20 resets the countdown timer 203.

Thus, an embodiment of an anti-seizure process implemented by the vacuum system 2 is provided.

The process of FIG. 3 may be performed continually or continuously during operation of the vacuum system 2. The process of FIG. 3 may be initiated (e.g. by the controller 20 or an external entity) in response to the vacuum system 2 or motor 12 being deactivated, e.g. stopped or paused. The process of FIG. 3 may be overridden (e.g. stopped or paused) in response to the vacuum system 2 or motor 12 being activated so as to draw gas from the facility 4. The process of FIG. 3 may be overridden by a higher priority process such as controlling the vacuum system 2 to a meet process demand.

Advantageously, the above described system and methods tend to prevent or reduce the likelihood of seizure of the liquid ring pump, for example, during long shutdown periods. For example, the periodic rotation of the impeller within the chamber tends to prevent or oppose the build-up of particulate matter, sediment, or debris which may otherwise inhibit movement of the impeller within the chamber. Liquid ring pumps typically use mechanical seals which tend to be able to handle only small particle sizes. Also, abrasion resistance tends to be limited. It tends to be important to avoid particle sedimentation between the mechanical seal sealing surfaces. Also, the periodic rotation of the impeller within the chamber tends to prevent or oppose corrosion of the impeller and/or chamber wall from bonding together the impeller and the chamber wall. Seizure between the shaft and the housing may also be prevented.

Advantageously, the above described system and methods tend to prevent or reduce oil separation from a bearing grease base material. This may occur on drives that remain idle for long periods of time, when the grease is churned excessively, and over time due to the designed normal bleed rate.

The above described system and methods may be performed automatically, under control of the controller.

In the above described control processes, the liquid ring pump is operated with variable frequency drive (VFD). In other words, the controller controls the liquid ring pump to vary the speed at which the liquid ring pump pumps gas from the facility. When VFD is used, there may be a risk of the liquid ring pump shutting down if it is run at too low a speed. If the liquid ring pump was to shut down, gas from the chamber of the liquid ring pump may attempt to flow back from the chamber and out of the liquid ring pump to the facility. The non-return valve advantageously tends to prevent or oppose this undesirable flow of gas, and is particularly beneficial for the liquid ring pump operated using VFD.

In the above embodiments, the controller causes the impeller to periodically move within the chamber by activating the motor, i.e. causing the motor to drive the liquid ring pump. For example, the controller may control an inverter to modulate a DC current pulse. However, in other embodiments, the controller (or another entity such as an entity remote from the vacuum system) causes the impeller to periodically move within the chamber in a different way. In other words, a different driver may drive the liquid ring pump other than the motor. For example, the controller may control the pump system (e.g. by controlling a motor that controls the pump) to inject a liquid (e.g. water, operating liquid, etc.) into the chamber of the liquid ring pump thereby to cause the impeller to rotate within the chamber. For example, a centrifugal pump of the pump system may be controlled to periodically spay liquid against the impeller within the chamber thereby to cause the impeller to move.

In the above embodiments, the controller comprises a countdown timer, and implements the countdown timer to determine that the impeller has been stationary (or that its speed is below a threshold speed) for the first predetermined time period. However, in other embodiments, the controller determines that the impeller has been stationary (or that its speed is below a threshold speed) for the first predetermined time period is a different way. For example, a different type of timer, such as a count-up timer, may be implemented.

In the above embodiments, the vacuum system comprises the elements described above with reference to FIG. 1. However, in other embodiments the vacuum system comprises other elements instead of or in addition to those described above. Also, in other embodiments, some or all of the elements of the vacuum system may be connected together in a different appropriate way to that described above. For example, in some embodiments, multiple liquid ring pumps may be implemented.

In the above embodiments, the heat exchanger cools the operating liquid flowing therethrough. However, in other embodiments other cooling means are implemented to cool the operating liquid prior to it being received by the liquid ring pump, instead of or in addition to the heat exchanger.

In the above embodiments, a separator is implemented to recycle the operating liquid back into the liquid ring pump. However, in other embodiments a different type of recycling technique is implemented. The recycling of the operating liquid advantageously tends to reduce operating costs and water usage. Nevertheless, in some embodiments, recycling of the operating liquid is not performed. For example, the vacuum system may include an open loop operating liquid circulation system in which fresh operating liquid is supplied to the liquid ring pump, and expelled operating liquid may be discarded. Thus, the separator may be omitted.

In the above embodiments, the liquid ring pump is a single-stage liquid ring pump. However, in other embodiments the liquid ring pump is a different type of liquid ring pump, for example a multi-stage liquid ring pump.

In the above embodiments, the operating liquid is water. However, in other embodiments, the operating liquid is a different type of operating liquid.

The controller may be a proportional-integral (PI) controller, a proportional (P) controller, an integral (I) controller, a derivative (D) controller, a proportional-derivative (PD) controller, a proportional-integral-derivative controller (PID) controller, a fuzzy logic controller, or any other type of controller.

In the above embodiments, a single controller controls operation of multiple system elements (e.g. the motor). However, in other embodiments multiple controllers may be used, each controlling a respective subset of the group of elements.

In the above embodiments, the pump is controlled to regulate or modulate flow of the operating liquid into the liquid ring pump. However, in other embodiments, one or more different type of regulating device is implemented instead of or in addition to the pump, for example one or more valves for controlling a flow of operating liquid. The controller may be configured to control operation of the one or more regulating devices. In some embodiments, the operating liquid flow is not modulated or regulated, and is drawn by the pump's vacuum inlet pressure.

1: A system comprising:
a liquid ring pump comprising a chamber and an impeller mounted within the chamber;
a driver configured to drive the liquid ring pump so as to cause the impeller to move within the chamber; and
a controller configured to, responsive to determining that a speed of the impeller relative to the chamber is below a threshold speed or is zero, control the driver to drive the liquid ring pump so as to cause the impeller to move within the chamber.

2: The system of claim 1, wherein
the controller is configured to determine that the speed of the impeller relative to the chamber has been below the threshold speed or has been zero at least for a first predetermined time period; and
wherein the controller is configured to control the driver to drive the liquid ring pump responsive to the controller determining that the speed of the impeller relative to the chamber has been below the threshold speed or has been zero at least for the first predetermined time period.

3: The system of claim 2, further comprising a timer configured to time the first predetermined time period.

4: The system of claim 3, wherein the controller is configured to:
responsive to determining that the speed of the impeller relative to the chamber is below a threshold speed or is zero, start the timer; and
after controlling the driver to drive the liquid ring pump, reset the timer.

5: The system of claim 1, further comprising one or more sensors configured to detect movement of the impeller relative to the chamber, wherein the controller is configured to determine that the speed of the impeller relative to the chamber is below the threshold speed or is zero using measurements taken by the one or more sensors.

6: The system of claim 1, wherein the controller is configured to determine that the speed of the impeller relative to the chamber is below the threshold speed or is zero using one or more of: a measurement of a speed of a motor arranged to drive the liquid ring pump; a measurement of a power consumption of the motor arranged to drive the liquid ring pump; a finite state machine of control software for controlling the liquid ring pump; and a measurement of vibration of the liquid ring pump.

7: The system of claim 1, wherein the driver comprises a motor configured to rotate a shaft upon which the impeller is mounted.

8: The system of claim 1, wherein the driver comprises a pump configured to inject an operating liquid into the chamber.

9: The system of claim 1, wherein the controller is configured to, responsive to determining that the speed of the impeller relative to the chamber is below the threshold speed or is zero, control the driver to cause the impeller to be moved periodically within the chamber.

10: The system of claim 1, wherein the controller is configured to, responsive to determining that the speed of the impeller relative to the chamber is below the threshold speed or is zero, control the driver to cause the impeller to be rotated within the chamber.

11: A method for controlling operation of a liquid ring pump, the liquid ring pump comprising a chamber and an impeller mounted within the chamber, the method comprising:
determining that a speed of the impeller relative to the chamber is below a threshold speed or is zero; and,
responsive to determining that the speed of the impeller relative to the chamber is below a threshold speed or is zero, controlling a driver to drive the liquid ring pump so as to cause the impeller to move within the chamber.

12: The method of claim 11, wherein determining that the speed of the impeller relative to the chamber is below the threshold speed or is zero comprises determining that the impeller is stationary relative to the chamber.

13: The method of claim 11, the method further comprises, repeatedly:
responsive to determining that the speed of the impeller relative to the chamber is below the threshold speed or is zero, starting a timer;
responsive to the timer timing a first predetermined time period for which the speed of the impeller relative to the chamber remains below the threshold speed or zero, controlling a driver to drive the liquid ring pump so as to cause the impeller to move within the chamber for a second predetermined time period; and
resetting the timer.

14: An anti-seizure apparatus for use with a liquid ring pump, the anti-seizure apparatus configured to, during a period of inactivity of the liquid ring pump, periodically drive the liquid ring pump.

15: A system comprising:
a liquid ring pump; and
a controller configured to activate the liquid ring pump responsive to determining that the liquid ring pump has been inactive for a predetermined time period.
